(19) United States
(12) Patent Application Publication
(10) Pub. No.: US 2025/0219745 A1
(43) Pub. Date: Jul. 3, 2025

(54) SPATIAL DOMAIN INTERFERENCE MITIGATION FOR SENSING IN A COMMUNICATION NETWORK

(71) Applicants: Fatemeh Hamidi-Sepehr, San Jose, CA (US); Thushara Hewavithana, Tempe, AZ (US); Rath Vannithamby, Portland, OR (US); Arvind Merwaday, Beaverton, OH (US)

(72) Inventors: Fatemeh Hamidi-Sepehr, San Jose, CA (US); Thushara Hewavithana, Tempe, AZ (US); Rath Vannithamby, Portland, OR (US); Arvind Merwaday, Beaverton, OH (US)

(21) Appl. No.: 18/399,902

(22) Filed: Dec. 29, 2023

(51) Int. Cl. H04B 17/345; H04W 72/044

(52) U.S. Cl. CPC H04B 17/345; H04W 72/044

(57) ABSTRACT

An apparatus can include transceiver circuitry to generate at least one sensing transmit beam. The apparatus can include a processor coupled to the transceiver circuitry to determine an interference field of view (FoV) of the at least one sensing transmit beam and receive a time or frequency resource allocation for subsequent transmissions based on the interference FoV information.

### TECHNICAL FIELD

Aspects pertain to wireless communications. Some aspects relate to interference mitigation.

### BACKGROUND

Radar sensing is a key envisioned feature in next generations of wireless systems, which allows using communication infrastructure and air interface components to also perceive the environment. Enabling efficient use of the radio spectrum to meet various communication and sensing use case requirements is one of the main goals in such systems.

### BRIEF DESCRIPTION OF THE FIGURES

In the figures, which are not necessarily drawn to scale, like numerals may describe similar components in different views. Like numerals having different letter suffixes may represent different instances of similar components. The figures illustrate generally, by way of example, but not by way of limitation, various aspects discussed in the present document.

FIG. 1 illustrates an architecture of a network in which some aspects of the disclosure may be implemented.

FIG. 2 illustrates an example of an Open RAN (O-RAN) system architecture in which some aspects of the disclosure may be implemented.

FIG. 3 illustrates a logical architecture of the O-RAN system of FIG. 2, in accordance with some aspects.

FIG. 4 illustrates inter-cell interference for sensing.

FIG. 5 illustrates interference field of view in accordance with some aspects.

FIG. 6 illustrates received interference power as a function of azimuth arriving angle.

FIG. 7 illustrates spatial multiplexing of sensing signals using the interference field of view in accordance with some aspects.

FIG. 8 is a flow diagram illustrating a method in accordance with some aspects.

FIG. 9 illustrates a block diagram of a communication device such as an evolved Node-B (eNB), a new generation Node-B (gNB) (or another RAN node), an access point (AP), a wireless station (STA), a mobile station (MS), or a user equipment (UE), in accordance with some aspects.

### DETAILED DESCRIPTION

The following description and the drawings sufficiently illustrate aspects to enable those skilled in the art to practice them. Other aspects may incorporate structural, logical, electrical, process, and other changes. Portions and features of some aspects may be included in or substituted for, those of other aspects. Aspects outlined in the claims encompass all available equivalents of those claims.

### Systems and Networks

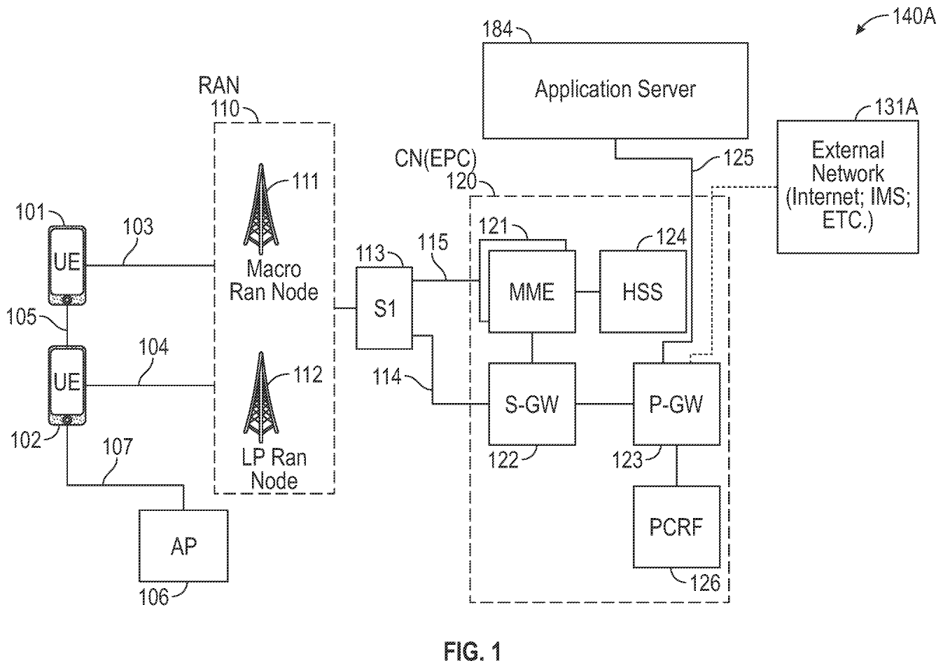

FIG. 1 illustrates an architecture of a network in which some aspects of the disclosure may be implemented. The network 140A is shown to include user equipment (UE) 101 and UE 102. The UEs 101 and 102 are illustrated as smartphones (e.g., handheld touchscreen mobile computing devices connectable to one or more cellular networks) but may also include any mobile or non-mobile computing device, such as Personal Data Assistants (PDAs), pagers, laptop computers, desktop computers, wireless handsets, drones, or any other computing device including a wired and/or wireless communications interface. The UEs 101 and 102 can be collectively referred to herein as UE 101, and UE 101 can be used to perform one or more of the techniques disclosed herein. Any of the radio links described herein (e.g., as used in the network 140A or any other illustrated network) may operate according to any exemplary radio communication technology and/or standard.

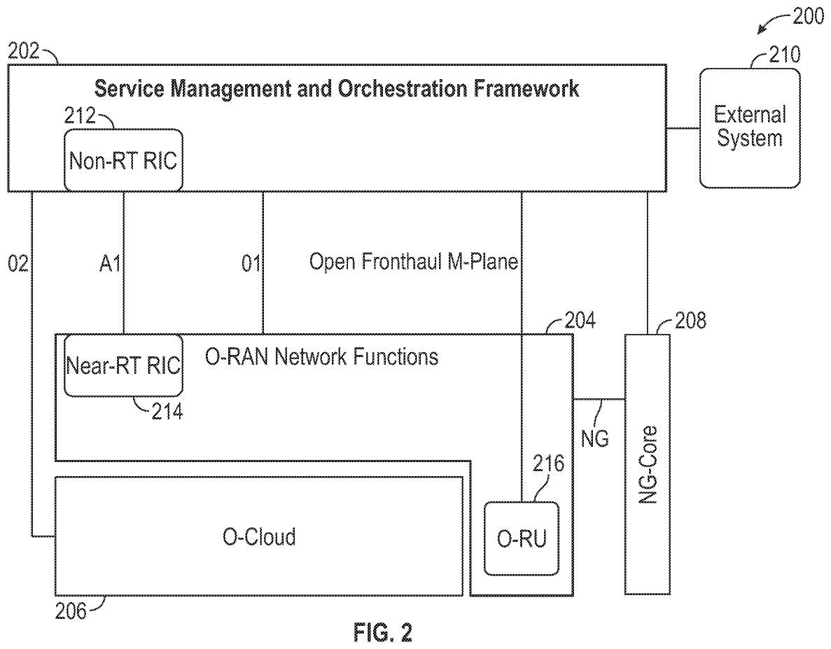

FIG. 2 provides a high-level view of an Open RAN (O-RAN) architecture 200, which can also be referred to as virtualized RAN (V-RAN). The O-RAN architecture 200 includes four O-RAN defined interfaces—namely, the A1 interface, the O1 interface, the O2 interface, and the Open Fronthaul Management (M)-plane interface—which connect the Service Management and Orchestration (SMO) framework 202 to O-RAN network functions (NFs) 204 and the O-Cloud 206. The SMO 202 also connects with an external system 210, which provides additional configuration data to the SMO 202. FIG. 2 also illustrates that the A1 interface connects the O-RAN Non-Real Time (RT) RAN Intelligent Controller (RIC) 212 in or at the SMO 202 and the O-RAN Near-RT RIC 214 in or at the O-RAN NFs 204. The O-RAN NFs 204 can be virtualized network functions (VNFs) such as virtual machines (VMs) or containers, sitting above the O-Cloud 206 and/or Physical Network Functions (PNFs) utilizing customized hardware. All O-RAN NFs 204 are expected to support the O1 interface when interfacing with the SMO framework 202. The O-RAN NFs 204 connect to the NG-Core 208 via the NG interface (which is a 3GPP-defined interface). The Open Fronthaul M-plane interface between the O-RAN Distributed Unit (DU) and the O-RAN Radio Unit (O-RU or simply RU) 216 supports the O-RU 216 management in the O-RAN hybrid model. The O-RU's termination of the Open Fronthaul M-plane interface is an optional interface to the SMO 202 that is included for backward compatibility purposes and is intended for management of the O-RU 216 in hybrid mode only. The O-RU 216 termination of the O1 interface towards the SMO 202 is specified in ORAN standards.

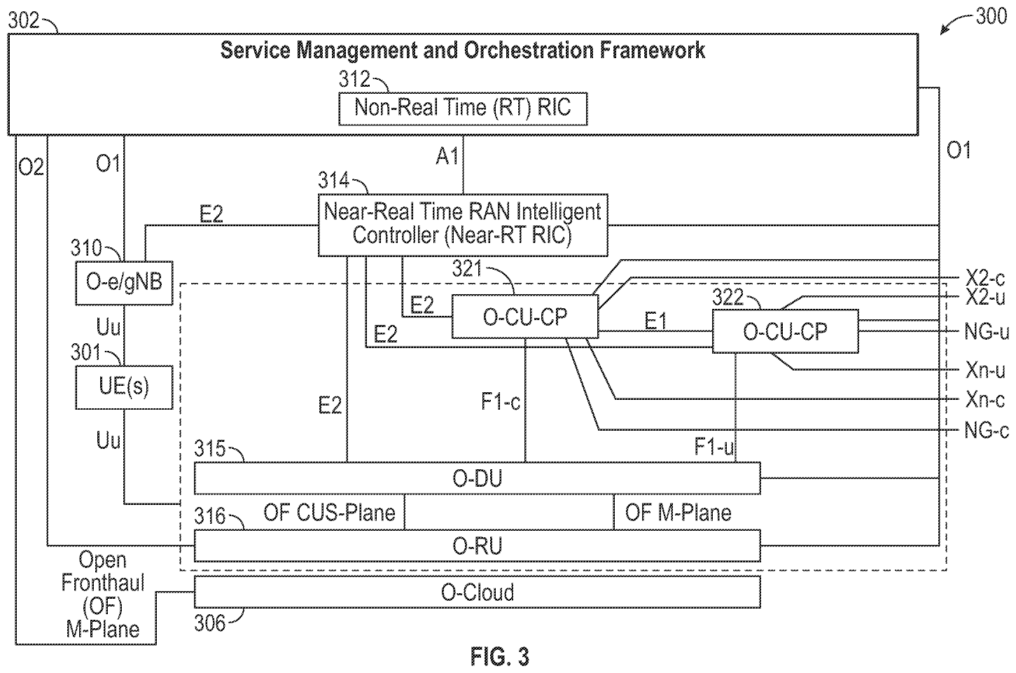

FIG. 3 shows an O-RAN logical architecture 300 corresponding to the O-RAN architecture 200 of FIG. 2. In FIG. 3, the SMO 302 corresponds to the SMO 202, O-Cloud 306 corresponds to the O-Cloud 206, the non-RT RIC 312 corresponds to the non-RT RIC 212, the near-RT RIC 314 corresponds to the near-RT RIC 214, and the O-RU 316 corresponds to the O-RU 216 of FIG. 2, respectively. The O-RAN logical architecture 300 includes a radio portion and a management portion.

The management portion/side of the architecture 300 includes the SMO Framework 302 containing the non-RT RIC 312 and may include the O-Cloud 306. The O-Cloud 306 is a cloud computing platform including a collection of physical infrastructure nodes to host the relevant O-RAN functions (e.g., the near-RT RIC 314, O-RAN Central Unit-Control Plane (O-CU-CP) 321, O-RAN Central Unit-User Plane (O-CU-UP) 322, and the O-RAN Distributed Unit (O-DU) 315), supporting software components (e.g., OSs, VMs, container runtime engines, ML engines, etc.), and appropriate management and orchestration functions.

The radio portion/side of the logical architecture 300 includes the near-RT RIC 314, the O-RAN Distributed Unit (O-DU) 315, the O-RU 316, the O-RAN Central Unit-Control Plane (O-CU-CP) 321, and the O-RAN Central Unit-User Plane (O-CU-UP) 322 functions. The radio portion/side of the logical architecture 300 may also include the O-e/gNB 310.

The O-DU 315 is a logical node hosting RLC, MAC, and higher PHY layer entities/elements (High-PHY layers) based on a lower-layer functional split. For example, a 7.2× split (or 7-2× split in some literature) between low PHY and high PHY may be implemented wherein L2, L3 and most of L1 processing is centralized at an O-DU. The O-RU 316 is a logical node hosting lower PHY layer entities/elements (Low-PHY layer) (e.g., FFT/iFFT, PRACH extraction, etc.) and RF processing elements based on a lower layer functional split. The O-CU-CP 321 is a logical node hosting the RRC and the control plane (CP) part of the PDCP protocol. The O O-CU-UP 322 is a logical node hosting the user-plane part of the PDCP protocol and the SDAP protocol.

### Spatial Domain Interference Mitigation for Sensing in Cellular Networks Mitigation

Joint communication and sensing (JCAS) can be implemented in any of the system architectures and networks described with respect to FIG. 1-FIG. 3. JCAS is one of the key technologies envisioned for advanced communication systems to support operation of both communication and sensing functions and potentially improve mutual performance with coordinated operation of the two functions. However, JCAS presents various challenges. For example, interference can impact JCAS system design. Aspects of the present disclosure address these and other concerns by providing spatial-domain interference handling for sensing in a JCAS system (e.g., systems using any of the above architectures/network designs).

The description below is made with reference to a monostatic case wherein the BS (e.g., any of the nodes 111, 112 (FIG. 1) or an O-RU 316 (FIG. 3)) uses its own transmitted signals and signal reflections to scan or monitor the environment, identify objects/targets, etc. Accordingly, the transmitter and receiver for a sensing node (e.g., any of the nodes 111, 112 (FIG. 1) or an O-RU 316 (FIG. 3)) would be the same network element, (e.g., the same BS, O-RU, etc. However, aspects of the present disclosure can be extended to other sensing topologies, such as bi-static and multi-static sensing between two or more BSs.

In this disclosure, the words/abbreviations BS, cell, gNB, and Transmission-Reception Point (TRP) may be interchangeably used to denote the network entity that transmits or receives radio signals. Aspects of the disclosure are equally applicable to different forms of network entity. A TRP can be understood to be a set of geographically co-located antennas (e.g., antenna array (with one or more antenna elements)) supporting transmission point and/or reception point functionality. A Transmission Point (TP) is defined as a set of geographically co-located transmit antennas (e.g. antenna array (with one or more antenna elements)) for one cell, part of one cell or one positioning reference signal (PRS)-only TP. Transmission Points can include base station (gNodeB) antennas, remote radio heads, a remote antenna of a base station, an antenna of a PRS-only TP (which only transmits PRS signals for PRS-based TBS positioning and is not associated with a cell [as defined in 3GPP TS 137.355]), etc. One cell can be formed by one or multiple transmission points. For a homogeneous deployment, each transmission point may correspond to one cell.

For the BS-based monostatic sensing scenario, the inter-cell interference problem consists of the BS receiving other BSs' signals (including communication or sensing signal) as interference to its own desired echoed and received sensing signal. Within a cell, the communication and sensing signal may be time-domain multiplexed, and as such no interference may be expected from communication transmission (to/from UEs) to the sensing operation.

Additional other forms of interference include co-site, inter-sector interference and self-interference between a BS's transmitter and receiver. For co-site, inter-sector interference, the problem is in many ways similar to the inter-cell interference problem, with the difference being that the interfering signal is much stronger, since it is coupled by somewhat closely spaced antenna that are co-located but arranged to transmit in different directions. Thus, for co-site, inter-sector interference, time domain isolation is often required. At least for the case when PRS signal (with potential extensions and adaptation) is used to perform sensing, the PRS sequences are mapped to different (i.e., orthogonal) time resources (different PRS resources corresponding to one PRS resource set in a cell are usually time domain multiplexed), and as such, intra-cell interference is greatly reduced. Co-site interference can also benefit from digital interference cancellation due to the close-proximity and thereby tighter timing achievable between inter-sector transmitters.

For self-interference, the design of the BS transmitter and receiver must take full duplex operation into account in their design so that the strong transmitter signal does not saturate the receiver. Physical separation between co-planar transmitter and receiver antenna panels affords considerable isolation, especially at higher frequencies. In addition, RF absorbing materials can be incorporated into the antenna panel design to increase transmit and receive isolation. Within the transmitter and receiver, both analog and digital self-interference cancellation algorithms can be applied to reduce the overall self-interference.

Since co-site, inter-sector interference and self-interference can be largely addressed through timing control and careful design practice, the largest remaining source of interference is inter-cell interference. Inter-cell interference, due to the large physical separation between BSs, cannot directly take advantage of the close timing available for self-interference and intra-site interference, so digital cancellation algorithms are much less feasible. Accordingly, the main problem for sensing operation for the BS, is caused by signals from other cells.

From the inter-cell interference perspective, for the case of sensing via PRS signal (with potential extensions/adaptations), sensing signal transmissions (e.g., PRS transmissions) from different cells, mainly rely on avoiding transmission on the same resources, by means of time domain and/or frequency domain separation. Aspects of the present disclosure therefore provide methods and apparatuses that can implement separation in spatial domain for mitigating or handling interference to the sensing operation.

Sensing signal design may allow for separation/orthogonality in multiple domains. For example, new radio (NR) PRS design supports separation of a PRS signal in the time domain (at the level of PRS resource, i.e., intra-slot-level, as well as at the level of resource set and repetitions across slots (inter-slot-level), i.e., via muting), in the frequency domain (via comb structure and using different subcarrier offsets for different cells to transmit over the same OFDM symbol), and in the sequence domain. For sensing via PRS signal (with potential extensions and adaptations), the same multi-domain separation can be maintained, which helps to avoid or reduce interference from sensing signals transmitted by other cells. Further, in case a new sensing signal is being adopted, similar multi-domain orthogonality may be supported.

Depending on a BSs' spacing and transmit powers, a BSs' self-signal echo may or may not be of lower power compared to signals from other BSs, which can accordingly impact the level of degradation in sensing performance caused by interference. For example, it may be the case that the direct path interference from an adjacent cell is a strong interferer compared to the reflected sensing signal in the current cell.

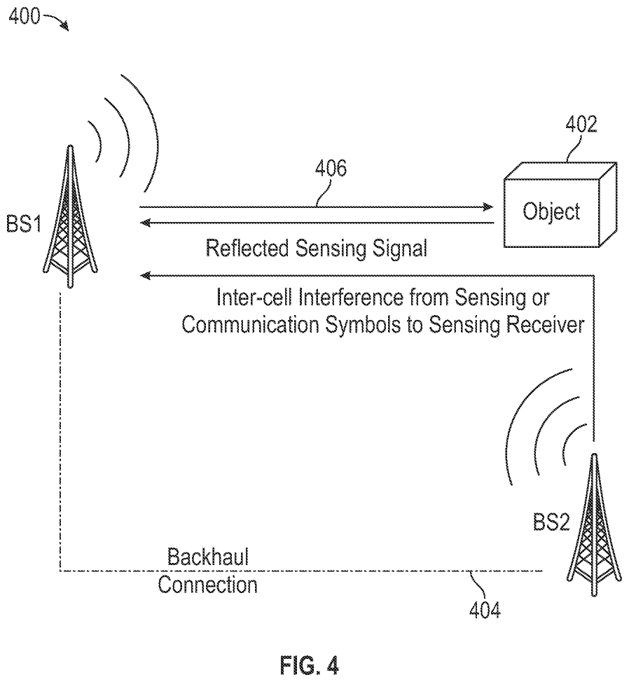

The interference to a BS's sensing signal can be from sensing or communication signals of other BSs as shown in FIG. 4. For example, in FIG. 4 BS 400 uses a reflected sensing signal to sense object 402. Interference can be caused to this sensing signal by inter-cell interference of BS 404.

Monostatic sensing (e.g., sensing provided by reflected signal sensing 406) can have approximately double the pathloss (in dB) compared to line of sight (LOS) communications, due to the distance that the sensing signal (and its reflection) need to travel between the transmitter and the receiver. To make up for the loss in received signal power, averaging or repetition of symbols can be used to achieve signal processing gain. The significant pathloss that sensing suffers from, compared to LOS communication, is also a factor in the situation of interference. Under interference, even averaging to compensate for sensing pathloss also picks up the interference strongly. As such, at least in certain scenarios, the interference from other cells' communication signals to one cell's sensing, may be more pronounced compared to the interference from other cells' communication signals to one cell's communication. Accordingly, in such scenarios, interference handling methods to mitigate the communication-to-communication interference, may not be adequate to deal with the interference from the communication to sensing (depending on the BSs distance, transmit powers, etc.). For such cases, some form of cooperative time domain multiplexing between cells may be the most effective way, which may be realized by muting with coordination between cells (helpful either for interference from other cells' communication signals or other cell's sensing signal). In general, separation of signals between signals from different BSs to address inter-cell interference, can be achieved in one or multiple domains.

Providing spatial orthogonality between sensing signals in different cells, can be dependent on several factors, including cells/sectors planning, desired sensing fields of view (FoVs), the placement, shapes, and material of objects in the environment, etc.

In general, beamforming for sensing signal transmission can be coordinated between cells to minimize inter-cell interference of sensing signals. This can be in addition to (combined with) other tools, such as using different sequences in sensing signal generation for different cells to mitigate/reduce potential intercell sensing interference.

In handling inter-cell interference of sensing signals, it is also noted that depending on the network topology, cell planning, and desired FoVs to be scanned for sensing, the direct sensing signal from adjacent cells may or may not be strong interferer compared to the reflected signal from a target in a current cell. In the description provided below for aspects of the present disclosure, by planning of beam directions from different nodes, the network will not necessarily need to assign mutually exclusive (time/frequency) resources everywhere in the neighboring (potentially interfering) cells. In certain cases, enough level of spatial separation (potentially combined with code domain separation) can be provided to enable reuse of resources.

In one aspect of the present disclosure, to provide spatial separation between signals from different cells/sectors, the impact area of signal reflections from targets in the FoVs of the sensing transmit beam(s) are separated between the BSs.

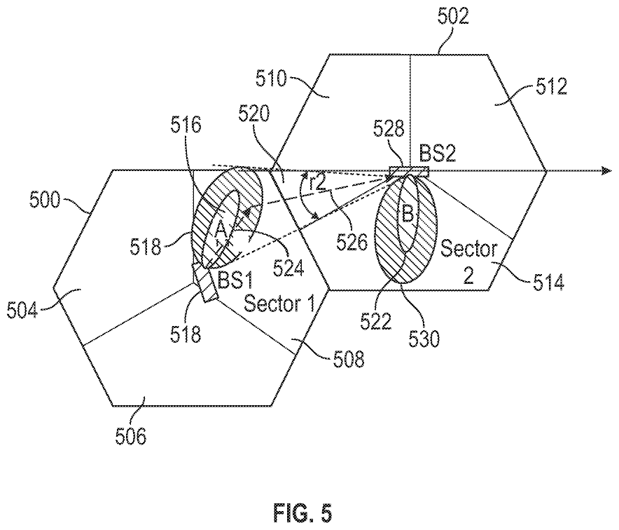

FIG. 5 illustrates interference field of view in accordance with some aspects. In FIG. 5, each cell 502, 504 has three sectors 506, 508, 510, 512, 514, 516; however, these are examples and aspects of the disclosure are not limited thereto. Consider beam 516 of Sector 508 (e.g., the massive MIMO antennas in the cell, are pointing in the shown direction, to cover Sector 508). To provide spatial separation for sensing operations in different cells, methods according to aspects of the present disclosure first identify how the sensing beam 516 (created by the antennas 518), may interfere with other cells' (e.g., cell 502) operation.

In one example, an interference field of view (FoV) can be defined for each of other cells' sector BSs (e.g., for Sector 514 BS), corresponding to each sensing transmit beam in a given cell's sector (e.g., corresponding to beam 516 from Sector 1 508 BS).

To illustrate the concept of interference FoV, consider the area 518 surrounding beam 516, which is the area for which a target can create a reflection that can cause interference to Sector 514 BS. It is noted that the direct path from beam 516 will be limited to the FoV of this beam, which consists of some cone-shape area 520 around beam 516 and will not interfere with beam 522 of Sector 514.

On the other hand, reflections of the transmitted sensing beam 516, throughout the area where the signal from beam 516 is strong enough (i.e., the area 518), can cause (strong enough) interference in the direction of Sector 514. While the area shown within 516 shows the power profile or the direction in which the main transmit power emits, a larger FoV area needs to be considered for interference management.

As such, any reflection which falls within the interference FoV (e.g., within cone 520) reaches the BS 528 antenna arrays and can cause sensing signal interference within that angle range. BS 528, then needs to create a sensing beam 530 (over same time/frequency resources), outside the interference FoV 520 from beam 516. Further, the sensing FoV of a beam 530 emitted by BS 528, as well as the interference FoV from that beam 530 to BS 518, should also be exclusive from the interference FoV from beam 516 (and the interference FoV 520 of beam 516), to avoid mutual interference. It is noted that for sensing detection and angular processing based on transmission of each beam, only the corresponding FoV (angle range) of the beam is considered, which is already separated from interference FoV from other beam(s).

In one example, the interference FoV area can be calculated assuming a maximum radar cross section (RCS) for a target (e.g., which may be falling at the far-end within a beam's transmit FoV) and applying the radar equation based on distance to TX and RX BS:

$${P}_{e} = \frac{{P}_{s} {G}_{1} {G}_{2} {λ}^{2} σ}{{( 4 π )}^{3} {r}_{1}^{2} {r}_{2}^{2}}$$

where: P_{S} is transmit power, distances r1, and r2 as shown in FIG. 5 as distance 524, 526 respectively, G₁, and G₂ are BS 518 and BS 528 antenna gains, λ is the signal wavelength, and σ radar cross section.

Normally, the network may not need to perform such calculation dynamically and may reuse the results over the operation interval. In one example, for the purpose of interference FoV calculation, the network keeps moving the assumed target around the FoV of the particular beam and measures the received reflected energy at the antenna array which may be the potential receiver of the interference. Depending on where the object is located, different amount of energy would be reflected towards the array, and can be measured.

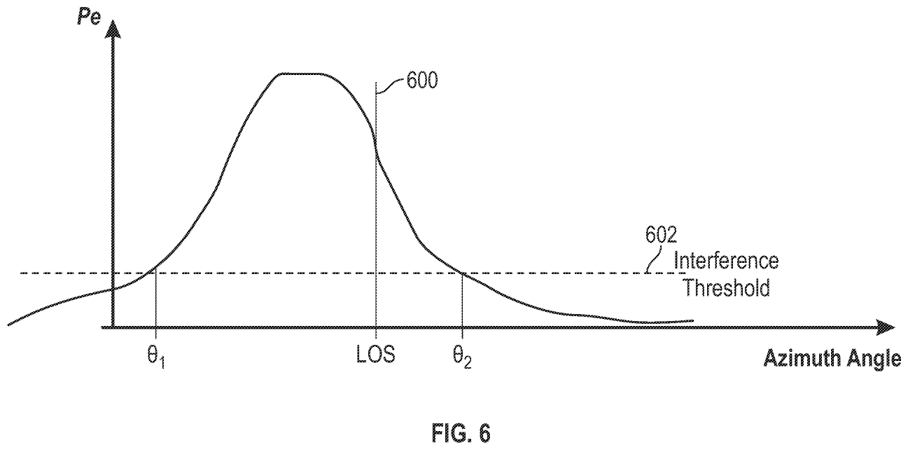

FIG. 6 illustrates received interference power as a function of azimuth arriving angle. FIG. 6 can illustrate for example how Pₑ may appear as a function of the azimuth (arriving) angle at BS 528. For a given arriving angle, certain target's location within the beam's FoV (e.g., which may be the closest point to the receive antenna) contributes to the maximum received interference power. On the other hand, It is noted that line of sight (LOS) path 600 may not necessarily cause the strongest interference level.

In one example, the network operator can set a (potentially non-zero) threshold 602 on tolerable interference considering all the factors, such as the level of interference mitigation provided by using different codes to apply to the sensing signal in the two base stations, etc., to determine the interference FoV. In the above example, the interference FoV is given by the θ₁ to θ₂ Azimuth angle range.

When calculating the threshold, it should also be noted that the code-domain separation can cause a noise floor and needs further randomization. If the threshold is set very low, (time/frequency) resources can be reused with sufficient spatial separation, without resorting to code domain separation. On the other hand, since code domain separation can be easily realized without much added complexity, overhead, or power consumption, code domain separation can be combined with spatial separation to increase the efficiency.

In one example, interference FoV (for each beam direction) can be calculated offline, e.g., using analytical tools, based on network topology information, the geometry, the cell and sectors mapping, and the orientation of antenna panels of base stations in the network.

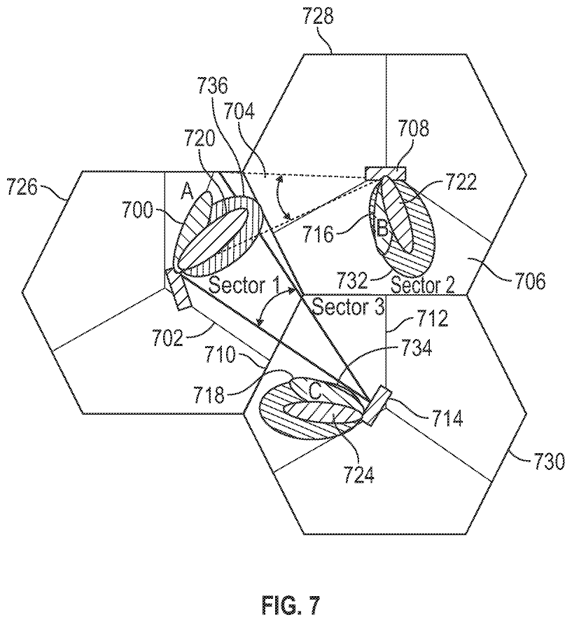

In one example, using the interference FoV idea according to aspects described above, spatial multiplexing of sensing signals can be realized as follows with reference to FIG. 7.

FIG. 7 illustrates spatial multiplexing of sensing signals using the interference field of view in accordance with some aspects. Consider beam 700 in Sector 702. This beam creates an interference FoV indicated within area 704 for Sector 706 BS 708, and interference FoV indicated by area 710 for Sector 712 BS 714. Hence Sector 706 and Sector 712 each can use same time frequency resources as Sector 702, to create beams 716, 718, respectively, with sensing FoV outside interference FoVs 704, 710. Herein, “sensing FoV” refers to the coverage (angle) that can be sensed by beams. It should also be ensured that Sectors 706, 712 beams' sensing FoVs do not interfere with each other. For example at a second or different time, beams 720, 722 and 724 may use a same time frequency resource for creating a sensing FoV. These should be controlled to not interfere with each other, by ensuring that areas 732, 734 and 736 to not creating overlapping interference FoVs with each other.

More beams can be added following this method, but a limited number of beams is shown in FIG. 7 for purposes of clarity. Accordingly, the network tries to illuminate the required area as much area as possible, using minimum amount of time/frequency resources.

In one example, the neighboring BSs that are in coordinating in a time slot may transmit a combination of sensing and communication signals. This provides scheduling flexibility for a gNB to transmit either a sensing signal or a communication signal in the coordinated slot, depending on the requirements.

In one example, geometry of the beams' FoV as well as the reflected path of signals from targets in FoV is considered when determining a given beams interference FoV on another BS.

After the cells transmit the beams 700, 716 and 718 beams shown in FIG. 7, the cells can move to the beams 720, 722, 724, and the process can continue until all three sectors of each cell 726, 728, 730 are swept without interfering with each other, due to the effective spatial multiplexing technique disclosed above (using the same time-frequency resources). This method provides an additional dimension to multiplex sensing signals.

The determination of the beam sequence of the BSs (as well as the time/frequency resource allocation and considerations on orthogonalization), can be conducted centrally, for example, via central coordination across the network nodes. This is aligned with O-RAN architecture with a centralized control, e.g., a C-RAN architecture, wherein multiple RUs in the local area of the network are connected to centralized DU using an architecture same or similar to that shown in FIG. 2 and FIG. 3. In these aspects, beams can be managed centrally by shared DU (e.g., O-DU 315) to avoid interfering with each other. For D-RAN architectures where each BS operates independently, implementation of this area may require synchronizing the beam sequences based on common timing reference (based on absolute timing grid established based on precision timing protocol (PTP), for example.

In certain scenarios and network topologies, there might be geometric impossibility to avoid interference. For example, despite attempting to dimension the transmit beams based on the corresponding interference FoVs, it may be the case that the transmit FoVs and/or interference FoVs end up pointing in the same or overlapping direction(s). In such cases, separation in time and/or frequency may be unavoidable.

Further, the spatial domain separation techniques, can be dependent on the BS's implementation, as well as the operation radio frequency. As such, spatial domain techniques and tools are expected to be supported in addition to dimensioning in other domains (e.g., time, frequency, and code domain).

For DL-PRS, based on the network implementation, it is possible to arrange antenna patterns so as to transmit beams with spatial orthogonality over the same time/frequency resources. However, the antenna pattern often have some overlap and side-lobes so that the degree of isolation may not be as high as other isolation methods, yet spatial isolation still adds an additional valued component toward reducing inter-cell interference. For sensing, especially in higher carrier frequencies, since the sensing is performed in a directional way, the coordination of the beams for transmission of sensing radio signal over time resources, may be helpful in reducing the level of interference.

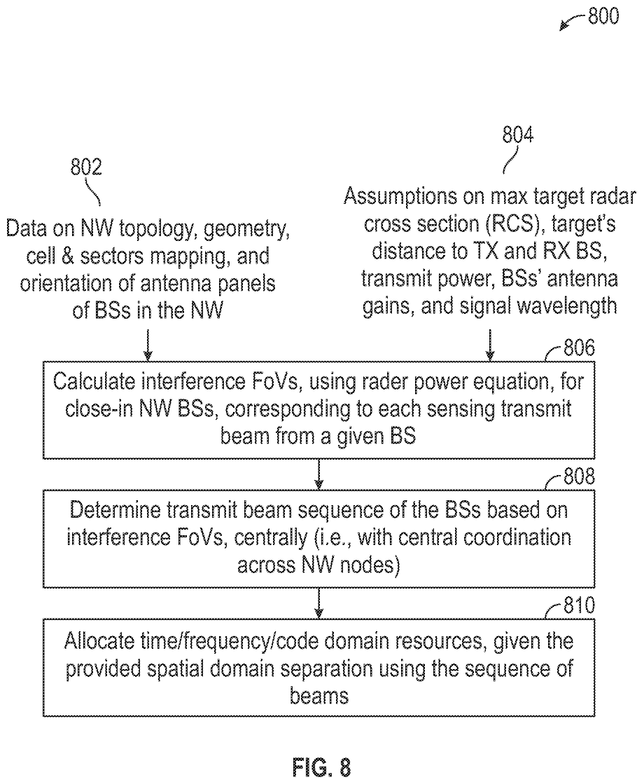

FIG. 8 is flowchart of a method 800 for realizing spatial domain separation in accordance with aspects of the disclosure. Inputs 802 can include data on network topology, geometry, cell and sector shaping, and orientation of antenna panels of BSs in the network. Inputs 804 can include assumptions regarding maximum target radar cross section (RCS), target distance to transmit and receive BS, transmit power, BS antenna gains, and signal wavelength as described above with reference to Equation (1).

In operation 806, a central system (e.g., a DU or other centralized node or unit) or individual BS can calculate interference FoVs, using for example Equation (1), for close in network BSs, corresponding to each sensing transmit beam from a given BS.

In operation 808, the central system (e.g., a DU or other centralized node or unit) can determine a transmit beam sequence of BSs based on the interference FoVs, centrally (e.g., with central coordination among multiple BSs). 810

In operation 810, the central system (e.g., a DU or other centralized node or unit) can allocate time/frequency or code domain resources given the provided spatial domain separation using the sequence of beams.

Aspects of the present disclosure provide a method for calculating interference FoV between the BSs in a network. Spatial domain separation can be realized to avoid interference on sensing operations. Isolation can be achieved by directing antenna patterns to focus energy in one direction while avoiding directing energy to sensitive directions/nodes. This provides another degree of freedom (spatial domain), in addition to time, frequency and code domain, for signal separation between the BSs in a network.

### Other Apparatuses and Description of Interfaces and Communications

LTE and LTE-Advanced are standards for wireless communications of high-speed data for UE such as mobile telephones. In LTE-Advanced and various wireless systems, carrier aggregation is a technology according to which multiple carrier signals operating on different frequencies may be used to carry communications for a single UE, thus increasing the bandwidth available to a single device. In some aspects, carrier aggregation may be used where one or more component carriers operate on unlicensed frequencies.

Aspects described herein can be used in the context of any spectrum management scheme including, for example, dedicated licensed spectrum, unlicensed spectrum, (licensed) shared spectrum (such as Licensed Shared Access (LSA) in 2.3-2.4 GHz, 3.4-3.6 GHz, 3.6-3.8 GHz, and further frequencies and Spectrum Access System (SAS) in 3.55-3.7 GHz and further frequencies).

Aspects described herein can also be applied to different Single Carrier or OFDM flavors (CP-OFDM, SC-FDMA, SC-OFDM, filter bank-based multicarrier (FBMC), OFDMA, etc.) and in particular 3GPP NR (New Radio) by allocating the OFDM carrier data bit vectors to the corresponding symbol resources.

Referring again to FIG. 1, the UEs 101 and 102 may be configured to connect, e.g., communicatively couple, with a radio access network (RAN) 110. The RAN 110 may be, for example, a Universal Mobile Telecommunications System (UMTS), an Evolved Universal Terrestrial Radio Access Network (E-UTRAN), a NextGen RAN (NG RAN), or some other type of RAN. The UEs 101 and 102 utilize connections 103 and 104, respectively, each of which comprises a physical communications interface or layer (discussed in further detail below); in this example, the connections 103 and 104 are illustrated as an air interface to enable communicative coupling and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth-generation (5G) protocol, a New Radio (NR) protocol, and the like.

In an aspect, the UEs 101 and 102 may further directly exchange communication data via a ProSe interface 105. The ProSe interface 105 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 102 is shown to be configured to access an access point (AP) 106 via connection 107. The connection 107 can comprise a local wireless connection, such as, for example, a connection consistent with any IEEE 802.11 protocol, according to which the AP 106 can comprise a wireless fidelity (WiFi®) router. In this example, the AP 106 is shown to be connected to the Internet without connecting to the core network of the wireless system (described in further detail below).

The RAN 110 can include one or more access nodes that enable connections 103 and 104. These access nodes (ANs) can be referred to as base stations (BSs), NodeBs, evolved NodeBs (eNBs), Next Generation NodeBs (gNBs), RAN network nodes, and the like, and can comprise ground stations (e.g., terrestrial access points) or satellite stations providing coverage within a geographic area (e.g., a cell). In some aspects, communication nodes 111 and 112 can be transmission/reception points (TRPs). In instances when the communication nodes 111 and 112 are NodeBs (e.g., eNBs or gNBs), one or more TRPs can function within the communication cell of the NodeBs. The RAN 110 may include one or more RAN nodes for providing macrocells, e.g., macro RAN node 111, and one or more RAN nodes for providing femtocells or picocells (e.g., cells having smaller coverage areas, smaller user capacity, or higher bandwidth compared to macrocells), e.g., low power (LP) RAN node 112 or an unlicensed spectrum based secondary RAN node 112.

Any of the RAN nodes 111 and 112 can terminate the air interface protocol and can be the first point of contact for the UEs 101 and 102. In some aspects, any of the RAN nodes 111 and 112 can fulfill various logical functions for the RAN 110 including, but not limited to, radio network controller (RNC) functions such as radio bearer management, uplink and downlink dynamic radio resource management, and data packet scheduling, and mobility management. In an example, any of the nodes 111 and/or 112 can be a new generation Node-B (gNB), an evolved node-B (eNB), or another type of RAN node.

The RAN 110 is shown to be communicatively coupled to a core network (CN) 120 via an Si interface 113. In aspects, the CN 120 may be an evolved packet core (EPC) network, a NextGen Packet Core (NPC) network, or some other type of CN. In this aspect, the Si interface 113 is split into two parts: the Si-U interface 114, which carries user traffic data between the RAN nodes 111 and 112 and the serving gateway (S-GW) 122, and the Si-mobility management entity (MME) interface 115, which is a signaling interface between the RAN nodes 111 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility aspects in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, the capacity of the equipment, the organization of the network, etc. For example, the HSS 124 can provide support for routing/roaming, authentication, authorization, naming/addressing resolution, location dependencies, etc.

The S-GW 122 may terminate the Si interface 113 towards the RAN 110, and route data packets between the RAN 110 and the CN 120. In addition, the S-GW 122 may be a local mobility anchor point for inter-RAN node handovers and also may provide an anchor for inter-3GPP mobility. Other responsibilities of the S-GW 122 may include a lawful intercept, charging, and some policy enforcement.

The P-GW 123 may terminate an SGi interface toward a PDN. The P-GW 123 may route data packets between the EPC network 120 and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks. Generally, the application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VoIP) sessions, PTT sessions, group communication sessions, social networking services, etc.) for the UEs 101 and 102 via the CN 120.

The P-GW 123 may further be a node for policy enforcement and charging data collection. Policy and Charging Rules Function (PCRF) 126 is the policy and charging control element of the CN 120. In a non-roaming scenario, in some aspects, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

An NG system architecture can include the RAN 110 and a 5G network core (5GC) 120. The NG-RAN 110 can include a plurality of nodes, such as gNBs and NG-eNBs. The core network 120 (e.g., a 5G core network or 5GC) can include an access and mobility function (AMF) and/or a user plane function (UPF). The AMF and the UPF can be communicatively coupled to the gNBs and the NG-eNBs via NG interfaces. More specifically, in some aspects, the gNBs and the NG-eNBs can be connected to the AMF by NG-C interfaces, and the UPF by NG-U interfaces. The gNBs and the NG-eNBs can be coupled to each other via Xn interfaces.

In some aspects, the NG system architecture can use reference points between various nodes as provided by 3GPP Technical Specification (TS) 23.501 (e.g., V15.4.0, 2018-12). In some aspects, each of the gNBs and the NG-eNBs can be implemented as a base station, a mobile edge server, a small cell, a home eNB, a RAN network node, and so forth. In some aspects, a gNB can be a master node (MN) and NG-eNB can be a secondary node (SN) in a 5G architecture. In some aspects, the master/primary node may operate in a licensed band and the secondary node may operate in an unlicensed band.

Referring again to FIG. 3, an E2 interface terminates at a plurality of E2 nodes. The E2 nodes are logical nodes/entities that terminate the E2 interface. For NR/5G access, the E2 nodes include the O-CU-CP 321, O-CU-UP 322, O-DU 315, or any combination of elements. For E-UTRA access the E2 nodes include the O-e/gNB 310. As shown in FIG. 3, the E2 interface also connects the O-e/gNB 310 to the Near-RT RIC 314. The protocols over the E2 interface are based exclusively on Control Plane (CP) protocols. The E2 functions are grouped into the following categories: (a) near-RT RIC 314 services (REPORT, INSERT, CONTROL, and POLICY, as described in O-RAN standards); and (b) near-RT RIC 314 support functions, which include E2 Interface Management (E2 Setup, E2 Reset, Reporting of General Error Situations, etc.) and Near-RT RIC Service Update (e.g., capability exchange related to the list of E2 Node functions exposed over E2).

FIG. 3 shows the Uu interface between UE 301 and O-e/gNB 310 as well as between the UE 301 and O-RAN components. The Uu interface is a 3GPP-defined interface, which includes a complete protocol stack from L1 to L3 and terminates in the NG-RAN or E-UTRAN. The O-e/gNB 310 is an LTE eNB, a 5G gNB, or ng-eNB that supports the E2 interface. The O-e/gNB 310 may be the same or similar to other RAN nodes discussed previously. The UE 301 may correspond to UEs discussed previously and/or the like. There may be multiple UEs 301 and/or multiple O-e/gNB 310, each of which may be connected to one another via respective Uu interfaces. Although not shown in FIG. 3, the O-e/gNB 310 supports O-DU 315 and O-RU 316 functions with an Open Fronthaul interface between them.

The Open Fronthaul (OF) interface(s) is/are between O-DU 315 and O-RU 316 functions. The OF interface(s) includes the Control User Synchronization (CUS) Plane and Management (M) Plane. FIG. 2 and FIG. 3 also show that the O-RU 316 terminates the OF M-Plane interface towards the O-DU 315 and optionally towards the SMO 302. The O-RU 316 terminates the OF CUS-Plane interface towards the O-DU 315 and the SMO 302.

The F1-c interface connects the O-CU-CP 321 with the O-DU 315. As defined by 3GPP, the F1-c interface is between the gNB-CU-CP and gNB-DU nodes. However, for purposes of O-RAN, the F1-c interface is adopted between the O-CU-CP 321 with the O-DU 315 functions while reusing the principles and protocol stack defined by 3GPP and the definition of interoperability profile specifications.

The F1-u interface connects the O-CU-UP 322 with the O-DU 315. As defined by 3GPP, the F1-u interface is between the gNB-CU-UP and gNB-DU nodes. However, for purposes of O-RAN, the F1-u interface is adopted between the O-CU-UP 322 with the O-DU 315 functions while reusing the principles and protocol stack defined by 3GPP and the definition of interoperability profile specifications.

The NG-c interface is defined by 3GPP as an interface between the gNB-CU-CP and the AMF in the 5GC. The NG-c is also referred to as the N2 interface (see [006]). The NG-u interface is defined by 3GPP, as an interface between the gNB-CU-UP and the UPF in the 5GC. The NG-u interface is referred to as the N3 interface. In O-RAN, NG-c and NG-u protocol stacks defined by 3GPP are reused and may be adapted for O-RAN purposes.

The X2-c interface is defined in 3GPP for transmitting control plane information between eNBs or between eNB and en-gNB in EN-DC. The X2-u interface is defined in 3GPP for transmitting user plane information between eNBs or between eNB and en-gNB in EN-DC. In O-RAN, X2-c and X2-u protocol stacks defined by 3GPP are reused and may be adapted for O-RAN purposes.

The Xn-c interface is defined in 3GPP for transmitting control plane information between gNBs, ng-eNBs, or between an ng-eNB and gNB. The Xn-u interface is defined in 3GPP for transmitting user plane information between gNBs, ng-eNBs, or between ng-eNB and gNB. In O-RAN, Xn-c and Xn-u protocol stacks defined by 3GPP are reused and may be adapted for O-RAN purposes.

The E1 interface is defined by 3GPP as being an interface between the gNB-CU-CP (e.g., gNB-CU-CP 3728) and gNB-CU-UP (see e.g., [007], [O09]). In O-RAN, E1 protocol stacks defined by 3GPP are reused and adapted as an interface between the O-CU-CP 321 and the O-CU-UP 322 functions.

The O-RAN Non-Real Time (RT) RAN Intelligent Controller (RIC) 312 is a logical function within the SMO framework 202, 302 that enables non-real-time control and optimization of RAN elements and resources; AI/machine learning (ML) workflow(s) including model training, inferences, and updates; and policy-based guidance of applications/features in the Near-RT RIC 314.

In some embodiments, the non-RT RIC 312 is a function that sits within the SMO platform (or SMO framework) 302 in the O-RAN architecture. The primary goal of non-RT RIC is to support intelligent radio resource management for a non-real-time interval (i.e., greater than 500 ms), policy optimization in RAN, and insertion of AI/ML models to near-RT RIC and other RAN functions. The non-RT RIC terminates the A1 interface to the near-RT RIC. It will also collect OAM data over the O1 interface from the O-RAN nodes.

The O-RAN near-RT RIC 314 is a logical function that enables near-real-time control and optimization of RAN elements and resources via fine-grained data collection and actions over the E2 interface. The near-RT RIC 314 may include one or more AI/ML workflows including model training, inferences, and updates.

The non-RT RIC 312 can be an ML training host to host the training of one or more ML models. ML training can be performed offline using data collected from the RIC, O-DU 315, and O-RU 316. For supervised learning, non-RT RIC 312 is part of the SMO 302, and the ML training host and/or ML model host/actor can be part of the non-RT RIC 312 and/or the near-RT RIC 314. For unsupervised learning, the ML training host and ML model host/actor can be part of the non-RT RIC 312 and/or the near-RT RIC 314. For reinforcement learning, the ML training host and ML model host/actor may be co-located as part of the non-RT RIC 312 and/or the near-RT RIC 314. In some implementations, the non-RT RIC 312 may request or trigger ML model training in the training hosts regardless of where the model is deployed and executed. ML models may be trained and not currently deployed.

The A1 interface is between the non-RT RIC 312 (within or outside the SMO 302) and the near-RT RIC 314. The A1 interface supports three types of services, including a Policy Management Service, an Enrichment Information Service, and an ML Model Management Service.

In some embodiments, an O-RAN network node can include a disaggregated node with at least one O-RAN Radio Unit (O-RU), at least one O-DU coupled via an F1 interface to at least one O-CU coupled via an E2 interface to a RIC (e.g., RIC 312 and/or RIC 314).

As illustrated in FIG. 2 and FIG. 3, key interfaces in O-RAN (e.g., defined and maintained by O-RAN) include the following interfaces: A1, O1, O2, E2, Open Fronthaul M-Plane, and O-Cloud. O-RAN network functions (NFs) can be VNFs, VMs, Containers, and PNFs. Interfaces defined and maintained by 3GPP which are part of the O-RAN architecture include the following interfaces: E1, F1, NG-C, NG-U, X2, Xn, and Uu interfaces.

As illustrated in FIG. 2 and FIG. 3, the following O-RAN control loops may be configured:
(a) Loop-1: (O-DU Scheduler control loop) TTI msec level scheduling;
(b) Loop-2: (Near-RT RIC) 10-500 msec resource optimization; and
(c) Loop-3: (Non-RT RIC) Greater than 500 msec, Policies, Orchestration, and SON.

As illustrated in FIG. 2 and FIG. 3, the following O-RAN nodes may be configured:
(a) O-CU-CP: RRC and PDCP-C NFs (associated with Loop-2);
(b) O-CU-UP: SDAP and PDCP-U NFs (associated with Loop-2);
(c) O-DU: RLC, MAC, and PHY-U NFs (associated with Loop-1); and
(d) O-RU: PHY-L and RF (associated with Loop 1).

As illustrated in FIG. 2 and FIG. 3, the following O-RAN RIC components may be configured:
(a) Non-RT-RIC: Loop 3 RRM services (O1 and A1 interfaces); and
(b) Near-RT-RIC: Loop 2 RRM services (E2 interface).

As illustrated in FIG. 2 and FIG. 3, the following O-RAN interfaces may be configured:
(a) A1 interface is between Non-RT-RIC and the Near-RT RIC functions; A1 is associated with policy guidance for control-plane and user-plane functions; Impacted O-RAN elements associated with A1 include O-RAN nodes, UE groups, and UEs;
(b) O1 interface is between O-RAN Managed Element and the management entity; O1 is associated with Management-plane functions, Configuration, and threshold settings mostly OAM & FCAPS functionality to O-RAN network functions; Impacted O-RAN elements associated with O1 include mostly O-RAN nodes and UE groups (identified e.g. by S-NSSAI and slice ID), sometimes individual UEs (pending solution for UE identifiers);
(c) O2 interface is between the SMO and Infrastructure Management Framework; O2 is associated with the management of Cloud infrastructure and Cloud resources allocated to O-RAN, FCAPS for O-Cloud; Impacted O-RAN elements associated with O2 include O-Cloud, UE groups, and UEs;
(d) E2 interface is between Near-RT RIC and E2 node; E2 is associated with control-plane and user-plane control functions; Impacted O-RAN elements associated with E2 include mostly individual UEs, sometimes UE groups and E2 nodes;
(e) E2-cp is between Near-RT RIC and O-CU-CP functions. E2-up is between Near-RT RIC and O-CU-UP functions;
(f) E2-du is between Near-RT RIC and O-DU functions. E2-en is between Near-RT RIC and O-eNB functions; and
(g) Open Fronthaul Interface is between O-DU and O-RU functions; this interface is associated with CUS (Control User Synchronization) Plane and Management Plane functions and FCAPS to O-RU; Impacted O-RAN elements associated with the Open Fronthaul Interface include O-DU and O-RU functions.

As illustrated in FIGS. 1-FIG. 3, the following 3GPP interfaces may be configured:
(a) E1 interface between the gNB-CU-CP and gNB-CU-UP logical nodes. In O-RAN, it is adopted between the O-CU-CP and the O-CU-UP.
(b) F1 interface between the gNB-CU and gNB-DU logical nodes. In O-RAN, it is adopted between the O-CU and the O-DU. F1-c is between O-CU-CP and O-DU functions. F1-u is between O-CU-UP and O-DU functions.
(c) The NG-U interface is between the gNB-CU-UP and the UPF in the 5GC and is also referred to as N3. In O-RAN, it is adopted between the O-CU-UP and the 5GC.
(d) The X2 interface connects eNBs or connects eNB and en-gNB in EN-DC. In O-RAN, it is adopted for the definition of interoperability profile specifications. X2-c is for the control plane. X2-u for a user plane.
(e) The Xn interface connects gNBs, and ng-eNBs, or connects ng-eNB and gNB. In O-RAN, it is adopted for the definition of interoperability profile specifications. Xn-c is for the control plane. Xn-u is for the user plane.
(f) The UE to e/gNB interface is the Uu interface and is a complete protocol stack from L1 to L3 and terminates in the NG-RAN. Since the Uu messages still flow from the UE to the intended e/gNB managed function, it is not shown in the O-RAN architecture as a separate interface to a specific managed function.

In example embodiments, any of the UEs or RAN network nodes discussed in connection with FIG. 1-FIG. 8 can be configured to operate using the techniques discussed herein associated with multi-access traffic management in an O-RAN architecture.

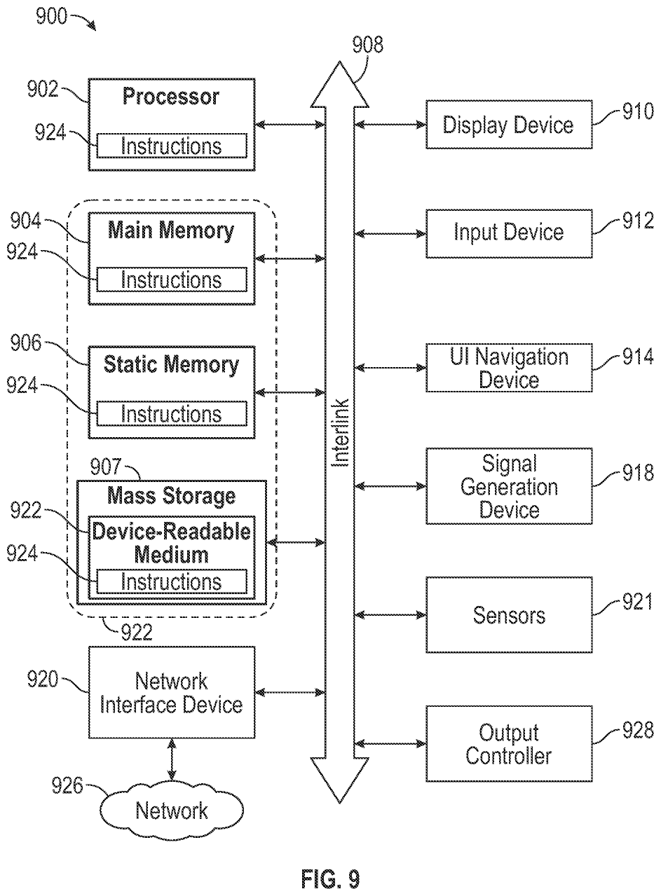

FIG. 9 illustrates a block diagram of a communication device such as an evolved Node-B (eNB), a new generation Node-B (gNB) (or another RAN node), an access point (AP), a wireless station (STA), a mobile station (MS), or a user equipment (UE), in accordance with some aspects and to perform one or more of the techniques disclosed herein. In alternative aspects, the communication device 900 may operate as a standalone device or may be connected (e.g., networked) to other communication devices.

The communication device may include a hardware processor 902 (e.g., a central processing unit (CPU), a graphics processing unit (GPU), a hardware processor core, or any combination thereof), a main memory 904, a static memory 906, and mass storage 907 (e.g., hard drive, tape drive, flash storage, or other block or storage devices), some or all of which may communicate with each other via an interlink (e.g., bus) 908.

The communication device 900 may further include a display device 910, an alphanumeric input device 912 (e.g., a keyboard), and a user interface (UI) navigation device 914 (e.g., a mouse). In an example, the display device 910, input device 912, and UI navigation device 914 may be a touchscreen display. The communication device 900 may additionally include a signal generation device 918 (e.g., a speaker), a network interface device 920, and one or more sensors 921, such as a global positioning system (GPS) sensor, compass, accelerometer, or another sensor. The communication device 900 may include an output controller 928, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The mass storage 907 may include a communication device-readable medium 922, on which is stored one or more sets of data structures or instructions 924 (e.g., software) embodying or utilized by any one or more of the techniques or functions described herein. In some aspects, registers of the processor 902, the main memory 904, the static memory 906, and/or the mass storage 907 may be, or include (completely or at least partially), the device-readable medium 922, on which is stored the one or more sets of data structures or instructions 924, embodying or utilized by any one or more of the techniques or functions described herein. In an example, one or any combination of the hardware processor 902, the main memory 904, the static memory 906, or the mass storage 907 may constitute the device-readable medium 922.

As used herein, the term “device-readable medium” is interchangeable with “computer-readable medium” or “machine-readable medium.” While the communication device-readable medium 922 is illustrated as a single medium, the term “communication device-readable medium” may include a single medium or multiple media (e.g., a centralized or distributed database, and/or associated caches and servers) configured to store the one or more instructions 924. The term “communication device-readable medium” is inclusive of the terms “machine-readable medium” or “computer-readable medium”, and may include any medium that is capable of storing, encoding, or carrying instructions (e.g., instructions 924) for execution by the communication device 900 and that causes the communication device 900 to perform any one or more of the techniques of the present disclosure, or that is capable of storing, encoding or carrying data structures used by or associated with such instructions. Non-limiting communication device-readable medium examples may include solid-state memories and optical and magnetic media. Specific examples of communication device-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, communication device-readable media may include non-transitory communication device-readable media. In some examples, communication device-readable media may include communication device-readable media that is not a transitory propagating signal.

Instructions 924 may further be transmitted or received over a communications network 926 using a transmission medium via the network interface device 920 utilizing any one of several transfer protocols. In an example, the network interface device 920 may include one or more physical jacks (e.g., Ethernet, coaxial, or phone jacks) or one or more antennas to connect to the communications network 726. In an example, the network interface device 920 may include a plurality of antennas to wirelessly communicate using at least one single-input-multiple-output (SIMO), MIMO, or multiple-input-single-output (MISO) techniques. In some examples, the network interface device 920 may wirelessly communicate using Multiple User MIMO techniques.

The term “transmission medium” shall be taken to include any intangible medium that is capable of storing, encoding, or carrying instructions for execution by the communication device 900, and includes digital or analog communications signals or another intangible medium to facilitate communication of such software. In this regard, a transmission medium in the context of this disclosure is a device-readable medium.

Example aspects of the present disclosure are further disclosed hereinbelow.

Example 1 is an apparatus comprising transceiver circuitry configured to generate at least one sensing transmit beam; and a processor coupled to the transceiver circuitry, the processor configured to: determine an interference field of view (FoV) of the at least one sensing transmit beam; and receive a time or frequency resource allocation for subsequent transmissions based on the interference FoV information.

In Example 2, the subject matter of Example 1 can optionally include wherein the interference FoV is calculated assuming a maximum radar cross section for a target falling within the FoV of the beam.

In Example 3, the subject matter of any of Examples 1-2 can optionally include wherein the interference FoV is calculated based on a distance from the apparatus to a second apparatus that is within the interference FoV of the beam.

In Example 4, the subject matter of Example 3 can optionally include wherein the apparatus and the second apparatus are radio units.

In Example 5, the subject matter of any of Examples 1-4 can optionally include wherein the processor is configured to refrain from transmitting in at least one time frequency resource based on an indication from a central unit that the apparatus is within an interference FoV of a second apparatus.

Example 6 is a non-transitory computer-readable medium including instructions that, when executed in a control device, cause the control device to perform operations including: receiving an indication of interference field of view (FoV) of at least one sensing transmit beam of at least one radio unit; and allocating at least one of time resources, frequency resources, and code domain resources based on the indication.

In Example 7, the subject matter of Example 6 can optionally include wherein the control device comprises an O-RAN Distributed Unit (O-DU).

In Example 8, the subject matter of any of Examples 6-7 can optionally include wherein the operations further include providing spatial domain separation by specifying a sequence of beams for a plurality of radio units.

In Example 9, the subject matter of any of Examples 6-8 can optionally include determining a sensing FoV of at least one sensing transmit beam of at least one radio unit; and allocating resources to avoid overlap of the sensing FoV and at least one interference FoV.

In Example 10, the subject matter of Example 8 can optionally include wherein the operations further include calculating FoV using an analytical tool based on knowledge of at least one of network topology information, network geometry, cell and sectors mapping, or orientation of antenna panels of radio units.

In Example 11, the subject matter of Example 8 can optionally include wherein the interference FoV is calculated assuming a maximum radar cross section for a target falling within the FoV of the beam.

In Example 12, the subject matter of Example 8 can optionally include wherein the interference FoV is calculated based on a distance from an interfering apparatus to a second apparatus that is within the interference FoV of the beam.

In Example 13, the subject matter of Example 12 can optionally include wherein the apparatus and the second apparatus are radio units.

In Example 14, the subject matter of Example 8 can optionally include wherein the operations include refraining from transmitting in at least one time frequency resource based on an indication from a central unit that an apparatus is within an interference FoV of a second apparatus.

Example 15 is a method for performing any of Examples 1-14.

Example 16 is a system comprising means for performing any of Examples 1-14.

Although example aspects have been described herein, it will be evident that various modifications and changes may be made to these aspects without departing from the broader scope of the present disclosure. Accordingly, the specification and drawings are to be regarded in an illustrative rather than a restrictive sense. This Detailed Description, therefore, is not to be taken in a limiting sense, and the scope of various aspects is defined only by the appended claims, along with the full range of equivalents to which such claims are entitled.

What is claimed is:

1. An apparatus comprising:
transceiver circuitry configured to generate at least one sensing transmit beam; and
a processor coupled to the transceiver circuitry, the processor configured to:
determine an interference field of view (FoV) of the at least one sensing transmit beam; and
receive a time or frequency resource allocation for subsequent transmissions based on the interference FoV information.

2. The apparatus of claim 1, wherein the interference FoV is calculated assuming a maximum radar cross section for a target falling within the FoV of the beam.

3. The apparatus of claim 1, wherein the interference FoV is calculated based on a distance from the apparatus to a second apparatus that is within the interference FoV of the beam.

4. The apparatus of claim 3, wherein the apparatus and the second apparatus are radio units.

5. The apparatus of claim 1, wherein the processor is configured to refrain from transmitting in at least one time frequency resource based on an indication from a central unit that the apparatus is within an interference FoV of a second apparatus.

6. A non-transitory computer-readable medium including instructions that, when executed in a control device, cause the control device to perform operations including:
receiving an indication of interference field of view (FoV) of at least one sensing transmit beam of at least one radio unit; and
allocating at least one of time resources, frequency resources, and code domain resources based on the indication.

7. The non-transitory computer-readable medium of claim 6, wherein the control device comprises an O-RAN Distributed Unit (O-DU).

8. The non-transitory computer-readable medium of claim 6, wherein the operations further include providing spatial domain separation by specifying a sequence of beams for a plurality of radio units.

9. The non-transitory computer-readable medium of claim 6, wherein the operations further include:
determining a sensing FoV of at least one sensing transmit beam of at least one radio unit; and
allocating resources to avoid overlap of the sensing FoV and at least one interference FoV.

10. The non-transitory computer-readable medium of claim 8, wherein the operations further include calculating FoV using an analytical tool based on knowledge of at least one of network topology information, network geometry, cell and sectors mapping, or orientation of antenna panels of radio units.

11. The non-transitory computer-readable medium of claim 8, wherein the interference FoV is calculated assuming a maximum radar cross section for a target falling within the FoV of the beam.

12. The non-transitory computer-readable medium of claim 8, wherein the interference FoV is calculated based on a distance from an interfering apparatus to a second apparatus that is within the interference FoV of the beam.

13. The non-transitory computer-readable medium of claim 12, wherein the apparatus and the second apparatus are radio units.

14. The non-transitory computer-readable medium of claim 8, wherein the operations include refraining from transmitting in at least one time frequency resource based on an indication from a central unit that an apparatus is within an interference FoV of a second apparatus.

15. A method for interference mitigation comprising:
receiving an indication of interference field of view (FoV) of at least one sensing transmit beam of at least one connected device; and
allocating at least one of time resources, frequency resources, and code domain resources based on the indication.

16. The method of claim 15, wherein the method is performed by an O-RAN Distributed Unit (O-DU).

17. The method of claim 15, further comprising:
providing spatial domain separation by specifying a sequence of beams for a plurality of radio units; and
calculating FoV using an analytical tool based on knowledge of at least one of network topology information, network geometry, cell and sectors mapping, or orientation of antenna panels of radio units.

18. The method of claim 17, wherein the interference FoV is calculated assuming a maximum radar cross section for a target falling within the FoV of the beam.

19. The method of claim 17, wherein the interference FoV is calculated based on a distance from an apparatus to a second apparatus that is within the interference FoV of the beam.

20. The method of claim 16, further comprising refraining from transmitting in at least one time frequency resource based on an indication from a central unit that an apparatus is within an interference FoV of a second apparatus.
